(19) United States
(12) Patent Application Publication
(10) Pub. No.: US 2025/0188383 A1
(43) Pub. Date: Jun. 12, 2025

(54) PERFUME CONCRETE AND ABSOLUTE WHICH ARE OBTAINED BY KETONE OR DIOXOLANE-TYPE SOLVENT EXTRACTION FROM SOLID NATURAL SUBSTANCES

(71) Applicant: L'OREAL, Paris (FR)

(72) Inventors: Géraldine DU ROIZEL, Aulnay-Sous-Bois (FR); Hervé DAVID, Aulnay-Sous-Bois (FR)

(73) Assignee: L'OREAL, Paris (FR)

(21) Appl. No.: 18/837,720

(22) PCT Filed: Apr. 19, 2023
(86) PCT No.: PCT/EP2023/060196

§ 371 Date: Aug. 12, 2024

(30) Foreign Application Priority Data
Apr. 20, 2022 (FR) FR2203635

(51) Int. Cl. C11B 9/02

(52) U.S. Cl. CPC C11B 9/025

(57) ABSTRACT

The present invention relates to a process for preparing perfume concrete and/or absolute which employs bringing particular, fresh, withered or dry, solid natural material(s) into contact with a first system of solvents comprising at least one “green” ketone or dioxolane-type solvent. Another subject of the invention is the perfume concrete and the perfume absolute obtained by the preparation process, a composition comprising the concrete and/or the absolute, and the use of the “green” ketone or dioxolane-type solvent to extract the concrete and/or the absolute with no chemical odour of solvent odour type.

The present invention relates to a process for preparing perfume concrete and/or absolute which employs bringing particular, fresh, withered or dry, solid natural material(s) into contact with a first system of solvents comprising at least one, preferably “green”, ketone or dioxolane-type solvent. Another subject of the invention is the perfume concrete and the perfume absolute obtained by the preparation process, a composition comprising the concrete and/or the absolute, and the use of at least one, preferably “green”, ketone or dioxolane-type solvent to extract the concrete and/or the absolute with no chemical odour of solvent odour type, intensive and powerful and/or very close to the natural material (biomass) extracted.

The cosmetics industry and in particular the perfumery industry includes numerous processes for the extraction of odorous molecules, such as effleurage, hydrodistillation, expression, atomization, supercritical CO₂ extraction, and the like. Among these, extraction by non-polar volatile solvents, such as n-hexane, represents, for certain natural raw materials, a good technique for the extraction of odorous molecules, in particular owing to a good solubilizing power, a lower boiling point than water and easy vacuum distillation. This technique is favoured for the large-scale production of absolutes, used as raw materials in perfumery, in particular in the case where hydrodistillation could not be applied due to the high boiling point of water, which could detrimentally affect the natural raw materials, notably plant materials. By this process, natural materials, in particular plant materials, are subjected to several successive washing operations with a first volatile organic solvent 1. Separation by settling and then the evaporation under vacuum of the solvent 1 make it possible to obtain the “concrete”. An optional treatment of the “concrete” with a second solvent 2, in particular ethanol, makes it possible to remove the impurities present (waxes, and the like) and thus to obtain the “absolute” after evaporation of the solvent 2 (see Kirk-Othmer Encyclopedia of Chemical Technology, “Perfumes”, John Wiley & Sons Inc., K. D. Perring, pp. 1 to 46 (2016) DOI: 10.1002/0471238961.1605180619030818.a01.pub3, and Ullmann's Encyclopedia of Industrial Chemistry, “Perfumes”, M. V. Ende, W. Sturm and K. Peters, Wiley-VCH Verlag GmbH & Co. KGaA, Weinheim, (2017) https://onlinelibrary.wiley.com/doi/epdf/10.1002/14356007.a19_171.pub2). Among these various extraction techniques, extraction by volatile solvents is the favoured method for obtaining “concretes” and then “absolutes” of certain natural materials, such as perfumery raw materials. To do this, solvents of petroleum origin, notably aliphatic solvents, are chosen in particular as solvent 1 (see, for example, Kirk-Othmer Encyclopedia of Chemical Technology, “Perfumes”, John Wiley & Sons Inc., K. D. Perring, pp. 1 to 46 (2016) DOI: 10.1002/0471238961.1605180619030818.a01.pub3, and Ullmann's Encyclopedia of Industrial Chemistry, “Perfumes”, M. V. Ende, W. Sturm and K. Peters, Wiley-VCH Verlag GmbH & Co. KGaA, Weinheim, (2017) https://onlinelibrary.wiley.com/doi/epdf/10.1002/14356007.a19_171.pub2).

For example, n-hexane is often used on the industrial scale due to a low cost price and its ability to dissolve a great variety of products, including plant oils, flavourings, fragrances and colours. On the other hand, n-hexane is a non-renewable solvent which is not very environmentally friendly. Moreover, the nature of the extraction solvent can result in a chemical odour, such as a petroleum ether odour, which differs from the odour of the original solid natural material. Moreover, the odours are not always long-lasting.

It is thus of great interest to find an alternative process for preparing concretes and/or absolutes which uses, in its process, a preferably “green” extraction solvent instead of solvent of petroleum origin such as n-hexane, and which in addition does not denature the odour of the absolute or which does not leave a “chemical” odour such as, for example, a petroleum ether, in the absolute.

In 1991, the concept of Green Chemistry was put forward. Its objective is to reduce or eliminate at source the use of hazardous substances in the design of new products. Subsequently, twelve principles of green chemistry were proposed, “Green Chemistry: Theory and Practice”, Oxford Science, New York, P. T. Anastas et al. (1998). The indicators of green chemistry, such as the E-factor or atom economy, make it possible to measure the various aspects of a chemical process by referring to the principles of green chemistry (see, for example, Kirk-Othmer Encyclopedia of Chemical Technology, Green Chemistry, Michael A. Matthews, Vol. 12, pp. 799 to 818, 19 Apr. 2013, https://doi.org/10.1002/0471238961.0718050513012020.a01, and ibid., Green Chemistry, Applications, Albert S. Matlack, pp. 1 to 33, https://doi.org/10.1002/0471238961.greematl.a01).

Natural material extraction with n-heptane has been described in order to obtain concretes and absolutes using n-heptane solvent of petrochemical origin and derived from a Commiphora wildii plant source (WO 2019/149701). However, the yields of concretes and absolutes are not always satisfactory with respect to the starting raw material. In addition, the odour may be less pleasant or further from that of the natural material with a “chemical” note. On the other hand, US 2021/022381, JPH08168355 and J. Food. Engin., vol. 93, Jan. 8, 2009, describe the extraction of vanillin with the ketonic solvent:acetone (i.e. boiling point 56.05° C., 1 atm). Again, the odour may be less pleasant, especially less intense or powerful and/or less close than the biomass before extraction.

It is also desirable to be able to extract a concrete and/or an absolute from fresh, withered or dry, solid natural material, notably plant material, using a preferably “green” solvent with no change in odour of the concrete and/or the absolute or an olfactory trace of the solvent which made it possible to extract said concrete(s) and absolute(s), in particular an odour of “non-natural” product, such as petroleum ether. Moreover, it is of great interest to obtain extraction yields which are very markedly improved in comparison with conventional extraction solvents.

These technical problems have been solved by the process of the invention.

Thus one subject of the invention is a process for preparing a perfume concrete and/or a perfume absolute employing at least one step of bringing into contact a) a first system of solvents comprising at least one ketone solvent and/or at least one dioxolane solvent, said solvent(s) having a boiling point at atmospheric pressure between 57° C. and 160° C., more particularly between 57° C. and 150° C.; more preferentially between 60° C. and 130° C., more particularly between 70° C. and 120° C.; notably the ketone and/or dioxolane solvent(s) is(are) chosen from a1) to a3) as defined below,
with:
b) one or more fresh, withered or dry solid natural materials chosen from:
   i) rose (Rosa platyrhodon, Rosa hesperrhodos, Rosa hulthemia and Rosa eurosa and more particularly Rosa centifolia and Rosa damascena) flowers, jasmine (Jasminum and more particularly Jasminum grandiflorum and Jasminum sambac) flowers, lavender flowers, lavandin (Lavandula stoechas, Lavandula hybrida, Lavandula angustifolia, formerly officinalis, and Lavandula latifolia and more particularly Lavandula hybrida abrial, Lavandula hybrida grosso, Lavandula hybrida reydovan, Lavandula hybrida sumian and Lavandula hybrida super) flowers, orange (Citrus sinensis or bitter orange Citrus aurantium L) blossom, tuberose (Agave polianthes or Polianthes tuberosa) flowers, ylang-ylang (Cananga odorata) flowers, violet (Viola odorata var. Victoria) flowers, and mimosa (Acacia dealbata, Acacia decurrens) flowers;
   ii) geranium (Pelargonium with in particular Cicconium, Magnipetala, Parvulipetala, Paucisignata, and more particularly Pelargonium graveolens) stems and leaves, patchouli (Pogostemon cablin and Pogostemon heyneanus) stems and leaves and petitgrain (Citrus aurantium, more particularly Citrus aurantium ssp. amara, or Citrus var. bigaradia, or Citrus aurantium ssp. aurantium) stems and leaves;
   iii) fruits chosen from anise (Pimpinella anisum), coriander (Coriandrum sativum), caraway (Carum carvi), cumin (Cuminum cyminum) and juniper (Juniperus, more particularly Juniperus communis, Juniperus oxycedrus, Juniperus thurifera, Juniperus phoenicea L.);
   iv) Citrus fruits such as bergamot (Citrus bergamia), varieties of lemon (Citronella, Citrus limonum), varieties of orange (Citrus sinensis L.), varieties of mandarin (Citrus reticulata), varieties of grapefruit (Citrus paradisi); preferably varieties of lemon, varieties of bergamot, varieties of mandarin, or varieties of grapefruit; preferably Citrus bergamia (bergamot), or Citrus paradisi (grapefruit);
   v) mace (Myristica fragrans) seeds, angelica (Angelica archangelica) seeds, celery (Apium graveolens) seeds and cardamom (Elettaria cardamomum) seeds, tonka (Dipteryx odorata) seeds or beans, Vanilla (Vanilla planifolia) pods and/or seeds, preferably cardamom (Elettaria cardamomum) seeds; vi) Angelica (Angelica archangelica) roots, vetiver (Vetiveria, and more particularly Vetiveria zizanioides, Vetiveria nemoralis and Vetiveria nigritana) roots and Iris, particularly Iris germanica and Iris pallida, roots; vii) sandalwoods (Santalum and more particularly Santalum album, Santalum ellipticum, Santalum spicatum), rosewoods (Aniba rosaeodora), cedarwoods (Cedrus, more particularly Cedrus atlantica and Juniperus cedrus) and lignum vitae (Bulnesia sarmientoi, Guaiacum officinale and Guaiacum sanctum);
   viii) herbs and grasses chosen from tarragon (Artemisia dracunculus), lemongrass (Cymbopogon and more particularly Cymbopogon citratus), sage (Salvia and more particularly Salvia officinalis and Salvia sclarea), mint (Mentha and more particularly Mentha aquatica, Mentha canadensis, Mentha spicata) and thyme (Thymus, more particularly Thymus vulgaris and Thymus zygis);
   ix) spruce needles and twigs, fir (Abies and more particularly Abies alba) needles and twigs, rosemary (Salvia rosmarinus, formerly Rosmarinus officinalis) needles and twigs, and pine (Pinus and more particularly Pinus sylvestris) needles and twigs;
   and
   x) resins and balms derived from galbanum (Ferula galbaniflua or Ferula gummosa), elemi (Canarium and more particularly Canarium commune, Canarium luzonicum and Canarium indicum), benzoin (Styrax and more particularly Styrax tonkinensis and Styrax benzoin), myrrh (Commiphora myrrha or Commiphora molmol and Commiphora opobalsamum) and olibanum (Boswellia, more particularly Boswellia sacra);
it being understood that:
   the seeds or beans v) can be with or without shells, preferably without shells; and
   when the first system of solvents comprises at least one ketone solvent which is acetone, then the acetone is not mixed with the hexane.

Another subject of the invention is a concrete and/or an absolute obtained from the preparation process as defined above.

Another subject is a composition, in particular a cosmetic composition, comprising at least one concrete and/or at least one absolute, it being understood that said concrete(s) and/or said absolute(s) is(are) obtained by the preparation process as defined above.

Another subject of the invention is a method for treating keratin materials, in particular human keratin materials such as the skin, or human keratin fibres such as the hair, employing the application, to the keratin materials, of concrete(s) and/or of absolute(s) obtained from the preparation process as defined above, it being understood that the concrete(s) and/or the absolute(s) can be contained in a cosmetic composition.

Another subject of the invention is a method for perfuming a support i) such as:
keratin materials, in particular human keratin materials such as the skin, or human keratin fibres such as the hair,
textile materials such as natural materials, for instance cotton, linen, silk and wool, or synthetic materials, for instance polyamides such as nylon, polyesters, acrylics or elastanes, for instance Spandex® and Lycra®,
wood,
paper,
articles made of leather, such as shoes or gloves, and/or
the atmosphere ii) (room fragrances, wardrobe fragrances),
   employing one or more concrete(s) as defined below and/or one or more absolute(s) as defined below, by applying or spraying the concrete(s) and/or the absolute(s) over the support(s) i) or into the ambient air ii), it being understood that the concrete and/or the absolute can be contained in a composition as defined below.

Another subject of the invention is the use of a system of solvent(s) a) comprising at least one ketone solvent and/or at least one dioxolane solvent, said solvent(s) having a boiling point at atmospheric pressure between 57° C. and 160° C., preferably between 57° C. and 150° C.; more preferentially between 60° C. and 130° C., more particularly between 70° C. and 120° C.; even more preferentially the ketone and/or dioxolane-type solvent(s) is(are) chosen from a1) to a3) as defined below, in order to extract a perfume concrete and/or a perfume absolute from fresh, withered or dry solid natural material(s) i) to x) b) as defined above, with no chemical odour such as a solvent odour of ketone or ketal type.

Another subject of the invention is the use of one or more concretes and/or of one or more absolutes which are obtained according to the preparation process as defined above for the perfuming of a support i) such as:
keratin materials, in particular human keratin materials such as the skin, or human keratin fibres such as the hair,
textile materials such as natural materials, for instance cotton, linen, silk and wool, or synthetic materials, for instance polyamides such as nylon, polyesters, acrylics or elastanes, for instance Spandex® and Lycra®,
wood,
paper,
articles made of leather, such as shoes or gloves, and/or
the atmosphere ii) (room fragrances, wardrobe fragrances),

It appears, unexpectedly, that the odours of the concrete(s) and/or absolute(s) according to the invention, in particular those floral odours or odours resulting from seeds or pods, deteriorate only slightly and remain long-lasting over time, and/or after application to keratin materials, in particular to the skin or to keratin fibres such as the hair. In particular, the fragrance notes of concrete(s) and/or of absolute(s) according to the invention are and/or remain powerful over time. Furthermore, the concrete(s) and/or the absolute(s) obtained according to the process of the invention are relatively stable with regard to external attacks, such as light, temperature and/or sweat.

In addition, the concrete and/or absolute preparation process according to the invention makes it possible in particular to obtain concretes and/or absolutes with a very satisfactory yield (at least comparable to those obtained with solvents of petroleum origin, in particular aliphatic solvents such as n-heptane) and having odours very close to the starting solid natural raw materials, with no “non-natural” olfactory trace related to the ketone and/or dioxolane-type solvent such as olfactory traces of ketone or of acetal. For example, on the olfactory level, the Vanilla absolute obtained by the process according to the invention has a characteristic odour of Vanilla pod without any ketone or ketal note, which is closer to the natural odour than that obtained with solvent extraction using aliphatic solvents such as n-hexane or n-heptane. The odorous extracts contained in the concretes and/or absolutes of the invention have an odour substantially similar to that of the starting plant raw material. The concretes and/or absolutes of the invention can be used in perfumery, in cosmetics and also for the perfuming of supports i) as described above or of the atmosphere.

For the purposes of the present invention and unless otherwise indicated:

The term “grinding”, also referred to as “comminution”, “attrition” or “crushing”, is understood to mean the operation consisting in dividing the solid natural material(s) down to the powder state, preferably fine powder state, preferably with a size of the particles of the powder of less than 900 μm; advantageously, the size of the particles is of between 10 μm and 500 μm.

The term “powder” means a composition in pulverulent form, which is preferably essentially free of dust. In other words, the particle size distribution of the particles is such that the weight content of particles which have a size of less than or equal to 50 micrometres (dust content), preferably less than or equal to 10 micrometres (dust content), is advantageously less than or equal to 5%, preferably less than 2% and more particularly less than 1% (particle size evaluated using a Retsch AS 200 Digit particle size analyser; oscillation height: 1.25 mm/screening time: 5 minutes). Advantageously, the size of the particles is between 10 μm and 500 μm. The “powder” of solid natural material(s) can be screened in order to obtain particles with upper limit sizes corresponding to the orifices or sizes of the meshes of the screen, particularly between 35 and 80 mesh (US). According to a particular embodiment of the invention, the size of the particles of the powder of solid natural material(s) is fine. According to the invention, this more particularly means a particle size of less than or equal to 900 μm. Preferentially, the powder is constituted of fine particles with a size of between 7 and 700 μm and better still between 100 nm and 500 μm.

A “dry” material is understood to mean a plant raw material from which water has been withdrawn; preferably, the moisture content, i.e. water content, is between 0% and 10%, preferably less than 5%, even more preferentially less than 2%, better still less than 1%, such as less than 0.5% by weight relative to the total weight of said solid material, optionally in powder form.

A “fresh” material is understood to mean the hydrated material from which water has not been withdrawn; it was preferably harvested a few hours to a few days (up to 15 days) before bringing into contact with the solvent(s) and kept at a compatible temperature and with a relative humidity enabling the water content in said material to be maintained with ±2% of water, preferably, the fresh materials have a water content of greater than 10% by weight of water relative to the total weight of said solid material, optionally in powder form. More preferentially, the fresh material(s) of the invention is(are) chosen from flowers, such as jasmine flowers, mimosa flowers, rose flowers, tuberose flowers, orange blossom and ylang-ylang flowers, and preferably these flowers are treated with the process of the invention in the day after picking, or in 2 to 5 days after picking, having taken care to have kept the flowers at a temperature of between 1° C. and 5° C.

A “withered” material is understood to mean a plant raw material which is a particular fresh material, of which the flowering is finished, and/or the dry material is stored for one to several days (up to 15 days) before being treated by the process according to the invention and from which, in addition, water has been withdrawn in an amount of less than 80% by weight, preferably of less than 50% by weight, such as 1% to 40% by weight, in particular 1% to 20% by weight. A “natural” material is understood to mean a raw material of plant origin.

A “perfume raw material” is understood to mean a material in the crude state extracted from nature comprising olfactory active principles used in perfumery, or in the preparation of perfumes.

A “perfume” is understood to mean a particular olfactory composition, highly concentrated, provided packaged and having a high olfactory concentration. A “perfume” is also understood to mean an eau de toilette, an eau de parfum or an eau de Cologne.

In general, perfumes are constituted of a mixture of perfumery ingredients which may also be classified into head notes, heart notes and base notes. The three notes correspond to the greater or lesser volatility of the ingredients of which they are composed: highly volatile head note, moderately volatile heart note and sparingly volatile base note.
(i) The head note, also called “top” note, is that which is first perceived by the sense of smell as soon as the perfume is in contact with the keratin material or any other substrate. However, it is the note which fades the fastest: it does not “last”. It is difficult to express the persistence time of this note, since it is very variable: from a few minutes to about ten minutes. It is essentially fresh and light. All the Citrus notes belong in particular to this category. In perfumery, they are grouped under the generic term hesperidic notes, which include orange, lemon, grapefruit, bergamot, orange blossom, neroli, and the like. Mention will also be made of herbal notes, such as lavender, laurel, thyme or rosemary, and anise, menthol, aldehyde, and the like, notes. Mention will also be made of eucalyptus notes.
(ii) The heart note, sometimes also called “middle note”, has a persistence which lasts from a few tens of minutes to a few hours, but its main characteristic is that it is not perceived until after a few minutes. Thus, it “starts” just before the head note dies off. It begins to express itself while the head note is gradually fading away. It is represented essentially by floral, fruity or spicy scents: lily of the valley, honeysuckle, violet, magnolia, cinnamon, geranium, jasmine, rose, Iris, raspberry, peach, and the like.
(iii) The base note, sometimes also called “bottom note”, gives a perfume its “durability”, persistence or staying power. It is perceptible several hours, indeed even several days, or even several weeks, after application onto clothing or onto a perfume blotter or scent strip, depending on the concentration of the perfume. Mention will be made, for example, of woods, roots, mosses, resins and animal or mineral substances, such as opoponax, musks, amber, sandalwood, benzoin, lichen, clove, sage, and the like. Mention will also be made of Vanilla, patchouli, coumarin, and the like, notes.

The term “plant” is understood to mean the group of photosynthetic organisms, the cells of which have a wall constituted of cellulose.

The term “solid” is understood to mean that the raw material has a consistency which is not liquid at ambient temperature (25° C.) and atmospheric pressure (760 mmHg), that is to say a composition of high consistency, which retains its shape during storage. In contrast to “fluid” or “liquid” compositions, it does not flow under its own weight, while being able to be relatively soft.

A “solvent” is understood to mean a substance which is liquid at ambient temperature (25° C.) and at atmospheric pressure, which has the property of dissolving, diluting or extracting other substances without chemically modifying them and without itself being chemically modified.

An “organic solvent” is understood to mean an organic substance, preferably liquid at ambient temperature and atmospheric pressure, capable of dissolving or dispersing another substance without chemically modifying it.

For the purposes of the present invention, the term “anhydrous” is understood to mean a liquid phase with a water content of less than 5% by weight, preferably less than 2% by weight and even more preferably less than 1% by weight relative to the weight of said liquid phase, or indeed even less than 0.5% and notably free of water, the water not being added during the preparation of the liquid phase, but corresponding to the residual water supplied by the mixed ingredients.

A “system of solvents” is understood to mean just one, preferably “green”, solvent or a mixture of several solvents, preferably two or three solvents, if the system of solvents is a mixture of solvents; preferably, at least one of the solvents of the solvent system is “green” and more preferentially all the solvents are “green”.

When reference is made to the temperature of the boiling point of the system of solvents comprising a mixture of solvents, it is understood that the boiling point at atmospheric pressure of each solvent of said mixture must comply with the temperature in question, i.e. have a boiling point between 57° C. and 160° C. at atmospheric pressure, preferably between 57° C. and 150° C.; more preferentially between 60° C. and 130° C., even more particularly between 70° C. and 120° C.

A “green” solvent is understood to mean a solvent which complies with at least one of the 12 principles of green chemistry.

A “ketone” solvent is understood to mean an organic solvent comprising one or more >C═O carbonyl groups, which is saturated or unsaturated, preferably saturated, acyclic, linear or branched, or cyclic, particularly comprising in total from 3 to 10 carbon atoms such as 3 to 7 carbon atoms, more particularly from 4 to 6 carbon atoms, preferentially from 4 to 5 carbon atoms, optionally substituted with one or more hydroxyl radicals and notably 1 hydroxyl radical, if the solvent is cyclic it may also be substituted with one or more linear or branched, preferably linear (C₁-C₄)alkyl groups, such as methyl, said ketone solvent having a boiling point above or equal to 25° C., and particularly below or equal to 180° C., more particularly between 50° C. and 160° C., preferably between 57° C. and 150° C.; more preferentially between 60° C. and 130° C., even more particularly between 70° C. and 120° C.

A “dioxolane-type” solvent is understood to mean an organic solvent comprising one or more 1,3-dioxolane groups, preferably one 1,3-dioxolane group, which is saturated or unsaturated, preferably saturated, acyclic, linear or branched, or cyclic, notably acyclic, particularly comprising in total from 3 to 10 carbon atoms, more particularly from 4 to 6 carbon atoms, preferentially 6 carbon atoms, if the solvent is cyclic it may be substituted with one or more linear or branched, preferably linear (C₁-C₄)alkyl groups, such as methyl.

Preferably, the 1,3-dioxolane solvent of the invention is derived from a ketone solvent, said oxo group(s) of which has(have) been protected in the form of cyclic acetal(s); more particularly the 1,3-dioxolane solvent is derived from the ketalisation reaction of ketone solvent as defined above, preferentially the ketalisation reaction is carried out starting from a ketone solvent and ethylene glycol.

The term “solid/liquid extraction” or “leaching” is understood to mean the process for completely or partially extracting one or more compounds of natural material in an appropriate solvent. Solid/liquid extraction (also symbolized by “liquid-solid”) covers a variety of extraction processes known to a person skilled in the art (see Extraction Liquid-Solid, Kirk-Othmer Encyclopedia of Chemical Technology, Richard J. Wakeman (2000); https://doi.org/10.1002/0471238961.1209172123011105.a01, and Extraction Liquid-Solid, Ullmann's Encyclopedia of Industrial Chemistry, T. Voeste et al., (2012) DOI: 10.1002/14356007.b03_07.pub2.

For the purposes of the present invention, the term “physiologically acceptable medium” is intended to denote a medium that is suitable for the topical administration of a composition. A physiologically acceptable medium is without unpleasant odour and/or unpleasant appearance, and is entirely compatible with the topical administration route.

A “keratin material” is understood to mean the skin, the scalp, the lips and/or skin appendages such as the nails and keratin fibres, such as, for example, body hair, the eyelashes, the eyebrows and head hair.

For the purposes of the invention, a “cosmetic composition” means any composition applied to a keratin material to produce a non-therapeutic hygiene, care, perfuming, conditioning or makeup effect contributing towards improving the well-being and/or enhancing the beauty and/or modifying the appearance of the keratin material onto which said composition is applied.

For the purposes of the invention, a “dermatological composition” means any composition applied to a keratin material to prevent and/or treat a disorder or dysfunction of said keratin material.

For the purposes of the invention, a “cosmetic treatment” means any non-therapeutic fragrancing, hygiene, care, conditioning or makeup effect contributing towards improving the well-being and/or enhancing the beauty and/or modifying the appearance or odour of the keratin material onto which said composition is applied.

The term “high-frequency” ultrasound is understood to mean sound, the frequency of which is greater than 100 kHz and, for the very high frequencies, greater than 1 MHz,

The term “low-frequency” ultrasound is understood to mean sound, the frequency of which is between 16 and 100 kHz.

The Process for Preparing the “Concrete” and/or the “Absolute”:

According to a particular embodiment of the invention, the first step of the process for preparing the concrete and/or absolute can be preceded by the drying of the solid natural material(s) i) to x) as defined above and/or optionally by the grinding of natural material(s) i) to x) as defined above.

### Step of Drying Solid Natural Material

According to a particular embodiment of the invention, the natural material(s) i) to x) used in the process was(were), beforehand, washed and/or rinsed with water and/or dried in the open air or using conventional thermal means at a temperature preferably between 10° C. and 35° C., or else dehydrated in a thermal or microwave oven, or at ambient temperature using, for example, a desiccator, optionally under vacuum, in particular containing silica or P₂O₅, or using a dehydrating agent.

### Grinding Step

According to a particular embodiment of the invention, one or more grinding(s) is(are) carried out on the fresh or dry natural material(s) i) to x) as defined above before bringing into contact with the first solvent system a) as defined above to result in the mixture a)+b). More particularly, the grinding(s) is(are) carried out at ambient temperature (25° C.) or at low temperature; in particular at a temperature below 0° C., below −10° C., more particularly below −30° C., even more particularly at a temperature below −70° C., in particular using dry ice, liquid nitrogen or a mixture including dry ice and/or liquid nitrogen, such as the combination of methanol and liquid nitrogen.

The grinding(s) of the natural material(s) i) to x) can be mechanical, such as the grinding using a pestle and mortar, a ball mill, a cryogenic grinder, a yagen, a planetary mill, an analytical mill, notably an analytical knife mill, a knife mill (blender) or using an industrial grinder/micronizer or industrial crusher, preferably an analytical mill, notably an analytical knife mill.

The grinding time depends on the result which is desired in terms of fineness of the ground material; generally, it is between 1 second and 5 minutes with an analytical mill, notably an analytical knife mill, preferably between 10 seconds and 1 minute, more preferentially between 20 seconds and 40 seconds.

According to another particular embodiment of the invention, the grinding of the natural material(s) is carried out after treatment with liquid nitrogen.

Preferably, the grinding(s) is(are) mechanical. More particularly, the grinding(s) is(are) carried out at ambient temperature (25° C.). More preferentially, the grinding(s) is(are) carried out on seeds, with or without shells, with or without the pod, of natural material(s), in particular plant natural material(s).

If the quality of the powder after grinding is not sufficiently fine, that is to say that the particles have a size of greater than 500 μm, the grinding step can be repeated with the same appliance or on another grinding appliance, in particular a grinder/micronizer.

Ideally, the size of the powder obtained after grinding(s) is between 500 nm and 900 μm, more particularly between 100 nm and 500 μm. The size of the powder obtained after grinding(s) is preferably between 500 nm and 100 μm, more particularly between 100 nm and 50 μm.

The particle size of the powder is evaluated according to the light scattering analysis with a dry powder.

According to a preferred embodiment of the invention, the grinding(s) of natural material(s) is(are) carried out on seeds, with or without shells, with or without pod, preferably without shells.

### The Natural Material(s) b):

Preferably, the fresh, withered or dry solid natural material(s) is(are) chosen from the following families:
i) flowers from: the four subgenera Rosa platyrhodon, Rosa hesperrhodos, Rosa hulthemia and Rosa eurosa and more particularly Rosa centifolia and Rosa damascena (rose), Jasminum and more particularly Jasminum grandiflorum and Jasminum sambac (jasmine), Lavandula stoechas, Lavandula hybrida, Lavandula angustifolia, formerly officinalis and Lavandula latifolia and more particularly Lavandula hybrida abrial, Lavandula hybrida grosso, Lavandula hybrida reydovan, Lavandula hybrida sumian and Lavandula hybrida super (lavender and lavendin), blossom form the orange Citrus sinensis or from the bitter orange Citrus aurantium L (orange blossom), Agave polianthes or Polianthes tuberosa (tuberose flowers), Cananga odorata (ylang-ylang flowers) and mimosa flowers (Acacia dealbata or Acacia decurrens flowers);
ii) geranium or pelargonium, with in particular Cicconium, Magnipetala, Parvulipetala, Paucisignata and more particularly Pelargonium graveolens (geranium) stems and leaves, Pogostemon cablin and Pogostemon heyneanus (patchouli) stems and leaves and Citrus aurantium, more particularly Citrus aurantium ssp. amara, or Citrus var. bigaradia, or Citrus aurantium ssp. aurantium, (petitgrain) stems and leaves;
iii) fruits chosen from Pimpinella anisum (anise), Coriandrum sativum (coriander), Carum carvi (caraway), Cuminum cyminum (cumin) and Juniperus, more particularly Juniperus communis, Juniperus oxycedrus, Juniperus thurifera, Juniperus phoenicea L., (juniper);
iv) Citrus fruits chosen from varieties of lemon, varieties of mandarin (Citrus reticulata), varieties of clementine (Citrus clementina), varieties of grapefruit, particularly bergamot (Citrus bergamia), lemon (Citronella, Citrus limonum), mandarin, such as Citrus reticulata, or of grapefruit (Citrus paradisi); preferably bergamot or grapefruit;
preferably Citrus bergamia (bergamot), or Citrus paradisi (grapefruit);
v) Myristica fragrans (mace) seeds, Angelica archangelica (angelica) seeds, Apium graveolens (celery) seeds and Elettaria cardamomum (cardamom) seeds, Dipteryx odorata (tonka) seeds or beans, Vanilla planifolia (Vanilla, and/or Vanilla pod, and/or Vanilla seeds), preferably Elettaria cardamomum (cardamom) seeds, Dipteryx odorata (tonka) seeds or beans and Vanilla planifolia (Vanilla and/or Vanilla pod) and even more preferentially cardamom;
vi) Angelica archangelica (angelica) roots, Vetiveria, and more particularly Vetiveria zizanioides, Vetiveria nemoralis and Vetiveria nigritana (vertiver) roots and Iris, more particularly Iris germanica and Iris pallida (Iris) roots;
vii) woods of Santalum and more particularly Santalum album, Santalum ellipticum, Santalum spicatum (sandalwood), woods of Aniba rosaeodora (rosewood), woods of Cedrus, more particularly Cedrus atlantica and Juniperus cedrus (cedarwood), and woods of Bulnesia sarmientioi, Guaiacum officinale and Guaiacum sanctum (lignum vitae);
viii) herbs and grasses chosen from Artemisia dracunculus (tarragon), Cymbopogon and more particularly Cymbopogon citratus (lemongrass), Salvia and more particularly Salvia officinalis and Salvia sclarea (sage), Mentha and more particularly Mentha aquatica, Mentha canadensis, Mentha spicata (mint) and Thymus, more particularly Thymus vulgaris and Thymus zygis (thyme); ix) spruce needles and twigs, needles and twigs of Abies and more particularly Abies alba (fir), needles and twigs of Salvia rosmarinus, formerly Rosmarinus officinalis (rosemary), and needles and twigs of Pinus and more particularly Pinus sylvestris (pine); and
x) resins and balms derived from Ferula galbaniflua or Ferula gummosa (galbanum), Canarium and more particularly Canarium commune, Canarium luzonicum and Canarium indicum (elemi), Styrax and more particularly Styrax tonkinensis and Styrax benzoin (benzoin), Commiphora myrrha or Commiphora molmol and Commiphora opobalsamum (myrrh) and Boswellia, more particularly Boswellia sacra (oliban).

Particularly iv), the Citrus fruits of the invention, are such as the varieties of Citrus bergamia (bergamot), the varieties of Citronella, Citrus limonum (lemon), the varieties of Citrus reticulata (mandarin), the varieties of Citrus paradisi (grapefruit); preferably Citrus bergamia (bergamot) or Citrus paradisi (grapefruit).

According to a particular embodiment, the Citrus fruits iv) of the invention are chosen from the varieties of lemon (Citronella, Citrus limonum), such as calamondin, bergamot, kumquat, citron, finger lime, yellow lemon, lime, makrut lime and yuzu, the varieties of mandarin (Citrus reticulata) and of clementine (Citrus clementina), such as Nova, Encorce, Fortune, Ortanique, Nour or MA3, Cassar, Hernandina, Marisol, Nules, Caffin, the varieties of grapefruit (Citrus maxima, Citrus grandis or Citrus paradisi), such as white or blood pomelo, white grapefruit, pink grapefruit, blood grapefruit; particularly bergamot (Citrus bergamia), lemon (Citronella, Citrus limonum), mandarin (Citrus reticulata) or grapefruit (Citrus paradisi); preferably bergamot (Citrus bergamia) or grapefruit (Citrus paradisi).

According to a particular embodiment, iv) is different from Citrus fruit peel.

According to a further embodiment, the fresh, withered or dry solid natural material(s) is(are) chosen from the families i) to iii) and v) to x) as defined above, preferably chosen from the family v) and more preferentially from the pods such as the Vanilla pods.

During the step of bringing a) into contact with b) of the process of the invention, it is preferred to use one or more fresh, withered or dry solid natural material(s) chosen from i) flowers, such as lavender, lavandin, jasmine, rose and orange blossom, and ii) seeds, with or without shells, such as cardamom.

According to a particular variant of the invention, the fresh, withered or dry solid natural material(s) is(are) chosen from the materials i) as described above.

According to one embodiment, the fresh, withered or dry solid natural material(s) is(are) chosen from lavandin.

According to another embodiment, the fresh or dry solid natural material is jasmine flowers.

According to another embodiment, the fresh, withered or dry solid natural material is rose flowers.

According to another embodiment, the fresh, withered or dry solid natural material is tuberose flowers.

According to another embodiment, the fresh, withered or dry solid natural material is mimosa flowers.

According to another embodiment, the fresh or dry solid natural material is orange blossom.

According to another embodiment, the fresh or dry solid natural material is ylang-ylang flowers.

According to a second advantageous variant, the fresh or dry solid natural material(s) is(are) chosen from v) mace seeds, angelica seeds, celery seeds and cardamom (Elettaria cardamomum) seeds, tonka seeds or beans, Vanilla pods or Vanilla seeds, preferably Vanilla pods or Vanilla seeds, more preferentially Vanilla pods, notably that have been ground.

Preferably, the fresh, withered or dry solid natural raw material(s) chosen from b) is(are) chosen from the families chosen from i) and v).

According to a particular embodiment, the solid natural raw material(s) b) is/are dry and preferably chosen from the families i) and v), preferably from the family v).

According to a particular embodiment of the invention, the fresh, withered or dry solid natural material(s) b) as defined above is(are) chosen from the botanical families resulting from flowers, stems and leaves, fruits such as pods, peels of Citrus fruits, seeds, roots, wood, herbs and grasses, needles and twigs of trees chosen from Citrus bergamia (bergamot), Aniba rosaeodora (rosewood or Brazilian rosewood), family of Juniperus, Cupressus and Cedrus (cedarwood), Citronella (lemon), Eugenia caryophyllata (clove), Ferula gummosa (galbanum), Pelargonium graveolens (geranium), Jasminum officinale var. grandiflorum (jasmine), Lavandula hybrida, Lavandula angustifolia, formerly officinalis, and Lavandula latifolia (lavandin, lavender), Evernia prunastri (oakmoss), Iris pallida and Iris germanica (orris), Citrus aurantium subspecies amara (orange blossom), Pogostemon cablin (patchouli), C. aurantium (petitgrain), Rosa, in particular Rosa damascena and Rosa centifolia (rose), Santalum album (sandalwood), Vetiveria zizanoides (vetiver), Viola odorata var. victoria (violet), Cananga odorata (ylang-ylang), Vanilla planifolia (Vanilla) and Elettaria cardamomum (cardamom).

More preferentially, the fresh, withered or dry solid natural material(s) of the invention is(are) chosen from the following botanical families: Elettaria cardamomum (cardamom), Jasminum officinale var. grandiflorum (jasmine), Rosa, in particular Rosa damascena and Rosa centifolia (rose), Citrus aurantium subspecies amara (orange blossom), and Lavandula angustifolia, formerly officinalis, and Lavandula latifolia (lavandin, lavender), Vanilla planifolia (Vanilla) and Acacia dealbata, Acacia decurrens (mimosa) flower.

Preferably, the fresh, withered or dry solid natural raw material(s) is(are) chosen from the families chosen from i) and v). More preferably natural raw material(s) is(are) chosen from i) jasmine (Jasminum and more particularly Jasminum grandiflorum and Jasminum sambac) flowers, Lavandula stoechas, Lavandula hybrida, Lavandula angustifolia, formerly officinalis and Lavandula latifolia and more particularly Lavandula hybrida abrial, Lavandula hybrida grosso, Lavandula hybrida reydovan, Lavandula hybrida sumian and Lavandula hybrida super (lavender and lavendin), and mimosa flowers (Acacia dealbata or Acacia decurrens flowers) v) mace seeds, angelica seeds, celery seeds and cardamom (Elettaria cardamomum) seeds, tonka seeds or beans, Vanilla pods or Vanilla seeds, even more preferably Vanilla pods notably that have been ground, even more particularly selected from tonka seeds or beans, Vanilla pods or Vanilla seeds, preferably tonka seeds or beans, or Vanilla pods or Vanilla seeds, more preferentially Vanilla pods or Vanilla seeds, even more preferably Vanilla pods notably that have been ground. More preferentially chosen from v) notably Vanilla pods and/or seeds, preferentially Vanilla pods, notably that have been ground.

### The First System of Solvent(s) a)

According to a preferred embodiment of the invention, the first solvent system comprises at least one ketone solvent having a boiling point, at atmospheric pressure, between 57° C. and 160° C., preferably between 57° C. and 150° C.; more preferentially between 60° C. and 130° C., more particularly between 70° C. and 120° C.

According to one embodiment of the invention, the solvent system a) comprises at least one ketone solvent chosen from a1) and a2) below, preferentially a1), particularly acyclic and notably of formula (I).

According to one particular embodiment, the solvent system a) comprises at least one ketone solvent a1), more particularly of formula (I):

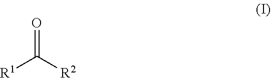

in which formula (I):
   R¹ or R², which are identical or different, represent a linear or branched C₁-C₅ alkyl group, optionally substituted with one or two hydroxyl groups, preferentially a (C₁-C₄)alkyl group, such as methyl, ethyl, n-propyl, i-propyl, n-butyl, 2-butyl or sec-butyl, i-butyl, t-butyl, n-pentyl; or else
   R¹ and R² form, with the carbon atom that bears the oxygen atom of the >C═O group, a cycloalkyl comprising from 5 to 6 members, preferably 5 members, which is saturated or unsaturated, preferably saturated, optionally substituted with one or more identical or different radicals chosen from hydroxyl or (C₁-C₄)alkyl such as methyl, preferably (C₁-C₂)alkyl such as methyl.

In particular, the solvents of formula (I) are chosen from linear or branched di(C₁-C₅)alkylketone solvents, and also the optical isomers thereof, i.e. for instance R¹ or R², which are identical or different, represent a linear or branched C₁-C₅ alkyl group, optionally substituted with one or two hydroxyl groups, notably one hydroxyl radical, preferentially a (C₁-C₄)alkyl group, such as methyl, ethyl, n-propyl, i-propyl, n-butyl, 2-butyl, i-butyl, t-butyl.

According to another variant, the solvents of formula (I) are chosen from cyclic solvents, i.e. R¹ and R² form, with the carbon atom that bears the oxygen atom of the >C═O group, a cycloalkyl comprising from 3 to 8 members, notably 5 to 6 members, preferably 5 members, which is saturated or unsaturated, preferably saturated, optionally substituted, by one or more hydroxyl radicals hydroxyl, or (C₁-C₄)alkyl such as methyl, preferably by one or more (C₁-C₂)alkyl such as methyl, more preferably by one (C₁-C₂)alkyl such as methyl.

Preferentially, the solvents a1) to a3) do not comprise a hydroxyl group.

According to another particular embodiment, the solvent system a) comprises at least one dicarbonyl solvent a2), in particular a di(C₁-C₅)alkyl-α,β-diketone or di(C₁-C₅)alkyl-α,γ-diketone solvent and also the optical isomers thereof, more particularly of formula (II):

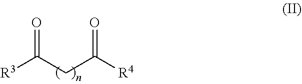

in which formula (II):
   R³ and R⁴, which are identical or different, represent a linear or branched C₁-C₃ alkyl group optionally substituted with one or two hydroxyl groups, preferably not substituted; and
   n represents an integer equal to 0 or 1.

According to another particular embodiment, the solvent system a) comprises at least one dioxolane-type solvent a3), in particular at least one solvent of di(C₁-C₅)alkyldioxolane type and also the optical isomers thereof, more particularly of formula (III):

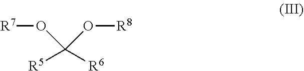

in which formula (III):
   R⁵ and R⁶, which are identical or different, represent a linear or branched C₁-C₃ alkyl group optionally substituted with a hydroxyl group, preferably not substituted;
   or else R⁵ and R⁶ form, with the carbon atom that bears them, a cycloalkyl comprising 5 carbon atoms, which is saturated or unsaturated, preferably saturated, optionally substituted, notably with one or more (C₁-C₄)alkyl, preferably (C₁-C₂)alkyl, groups, such as methyl;
   R⁷ and R⁸, which are identical or different, represent a C₁-C₃ alkyl group; or else the two groups R⁷ and R⁸ form, together with the oxygen atoms that bear them, a heterocycle comprising from 4 to 8 members, preferably from 5 to 6 members, which is saturated, more preferentially 5 members, it being possible for said heterocycle to optionally be substituted, notably by a (C₁-C₄)alkyl radical, in particular C₁-C₂ alkyl radical such as methyl, and preferably said heterocycle not being substituted.

As examples of carbonyl or dioxolane-type solvents of the invention, mention may be made of the solvents chosen from:
2) methyl ethyl ketone (CAS RN 78-98-3), 3) methyl propyl ketone (CAS RN 107-87-9), 4) methyl butyl ketone (CAS RN 591-78-6), 5) methyl isopropyl ketone (CAS RN 563-80-4), 6) methyl isobutyl ketone (CAS RN 108-10-1), 7) 3-methyl-2-pentanone (CAS RN 565-61-7), 8) tert-butyl methyl ketone (CAS RN 75-97-8), 9) 3-pentanone (CAS RN 96-22-0), 10) 3-hexanone (CAS RN 589-38-8), 11) ethyl isopropyl ketone (CAS RN 565-69-5), 12) 2,4-dimethyl-3-pentanone (CAS RN 580-80-0), 13) 2-methyl-3-hexanone (CAS RN 7379-12-6), 14) 2-methyl-3-pentanone (CAS RN 565-69-5), 15) 2,2-dimethylcyclopentanone (CAS RN 4541-32-6), 16) 2-methylcyclopentanone (CAS RN 1120-72-5), 17) 3-methylcyclopentanone (CAS RN 1757-42-2), 18) 2-methyl-2-ethyl-1,3-dioxolane (CAS RN 126-39-6), 19) 1-hydroxy-2-butanone (CAS RN 5077-67-8), 20) 3-hydroxy-2-butanone or acetoin (CAS RN 51555-24-9 or CAS RN 513-86-0), 21) 3-hydroxy-3-methyl-2-butanone (CAS RN 115-22-0), 22) 2,3-hexanedione (CAS RN 3848-24-6), 23) 3,4-hexanedione (CAS RN 4437-51-8), 24) 2,3-pentanedione (CAS RN 600-14-6), 25) 2,3-butanedione (CAS RN 431-03-8), 26) 2,4-pentanedione (CAS RN 123-54-6).

Particularly, the first solvent system according to the invention comprises at least one solvent chosen from 2), 3), 4), 5), 6), 7), 8), 9), 10), 11), 12), 13), 14), 16), 18), 19), 20), 21), 22), 23), 24), 25) and 26), more particularly chosen from 2), 3), 6), 9), 10), 16), 18), 25 and 26), even more particularly from 2), 6), 9), 16), 18), and even more preferably 6), 9), and 18).

According to another variant, the first solvent system according to the invention comprises at least one solvent chosen from: 2), 3), 4), 5), 6), 7), 8), 9), 10), 11), 12), 13), 14), 20), 24) and 25), more particularly 2), 6), and 9).

According to one embodiment of the invention, the first solvent system does not comprise any n-hexane solvent, particularly does not comprise any alkane saturated hydrocarbon. According to one embodiment of the invention, the first solvent system does not comprise any unsaturated hydrocarbon.

According to a particular embodiment, the process of the invention does not employ any n-hexane solvent, particularly does not employ any saturated hydrocarbon. According to one embodiment of the invention, the process of the invention does not employ any unsaturated hydrocarbon.

Preferentially, all the solvents used in the process of the invention are preferably “green” solvents.

The solvent(s) of the invention, if they comprise at least one asymmetric carbon, may be an enantiomerically pure (R) or (S), or in racemic form, or a mixture of these various forms, or a mixture of different (R) and (S) contents.

Preferably, the first solvent system comprises at least 50% by volume of ketone and/or dioxolane-type solvent having a boiling point at atmospheric pressure between 57° C. and 150° C.; more preferentially between 60° C. and 130° C., even more particularly between 70° C. and 120° C.; in particular the ketone and/or dioxolane solvent(s) is(are) chosen from a1) to a3) as defined above relative to the total volume of the first solvent system. More preferentially at least 60% by volume of ketone and/or dioxolane-type solvent as defined above, by volume relative to the total volume of the first solvent system. Even more preferentially, at least 80% by volume of ketone and/or dioxolane-type solvent as defined above relative to the total volume of the first solvent system, better still at least 90% by volume of ketone and/or dioxolane-type solvent as defined above relative to the total volume of the first solvent system, even better still 100% by volume of ketone and/or dioxolane-type solvent as defined above relative to the total volume of the first solvent system.

More particularly, when the system of solvent(s) a) comprises one or more additional solvents different from the ketone and/or dioxolane solvent(s) with a boiling point at atmospheric pressure between 50° C. and 160° C., preferably between 57° C. and 150° C.; more preferentially between 60° C. and 130° C., even more particularly between 70° C. and 120° C., at least one additional solvent is “green” and preferably all the additional solvents are “green”.

According to a particular embodiment, the additional solvent(s) are chosen from:
(A) polar protic solvents or protogenic solvents i.e. solvents having one or more hydrogen atoms capable of forming hydrogen bonds. Mention may be made of water and (C₁-C₈) alkanols with the alkane group being linear or branched, in particular alcohols such as bioethanol, 1-propanol, isoamyl alcohol, 2-pentanol or isopropanol;
(B) polar aprotic solvents i.e. solvents having a non-zero dipole moment and devoid of hydrogen atoms capable of forming hydrogen bonds. Mention may for example be made of esters of organic acids such as ethyl acetate, isopropyl acetate, propyl acetate, t-butyl acetate, isobutyl acetate, methyl propionate, methyl butyrate, methyl isobutyrate, methyl isovalerate or methyl 2-methylbutyrate, and C₁-C₄ alkyl carbonates, such as dimethyl carbonate; and
(C) non-polar aprotic solvents, i.e. having a zero permanent dipole moment. For example, hydrocarbons: linear or branched alkanes, cyclic alkanes, alkenes other than n-hexane.
   Preferably, the additional solvent(s) are chosen from (A), (B) and mixtures thereof.

More particularly, the “green” additional solvents different from the heterocyclic solvent(s) having a boiling point above or equal to 25° C. of the invention are chosen from the following families:
esters of organic acids, such as ethyl acetate, isopropyl acetate, propyl acetate or t-butyl acetate, preferably isopropyl acetate;
alcohols such as bioethanol or isopropanol;
C₁-C₄ alkyl carbonates, such as dimethyl carbonate;
and mixtures thereof.

According to one embodiment of the invention, the system of solvent(s) a) of the process is devoid of dimethyl carbonate. More particularly, the process of the invention does not employ dimethyl carbonate.

According to a particular embodiment, the first system of solvents has a density of less than 2, and in particular of less than or equal to 1.5, preferably of between 0.7 and 1.5.

Each of the solvents used in the system of solvents has a purity of at least 95%, notably of at least 97%, in particular of at least 99%.

Bringing the System of Solvent(s) a) into Contact with b) Solid Natural Material(s)

According to a particular embodiment of the invention, the solid natural material(s) i) to x), ground or unground, in the form of preferably dry powder(s), as defined above, is(are) brought into contact a) with a first system of solvent(s), as defined above, to form a heterogeneous a)+b) mixture.

According to another particular embodiment of the invention, the solid natural material(s) i) to x), in particular the materials i) as defined above, are used fresh is(are) brought into contact a) with a first system of solvent(s), as defined above, to form a heterogeneous a)+b) mixture.

More particularly, the contacting operation is carried out at ambient temperature, with or without stirring, preferably with stirring. The natural material(s) i) to x) as defined above is(are) more particularly left to macerate or infuse at a temperature of between 20° C. and 40° C., such as 20° C., in the system of solvent(s) as defined above. According to another form of the invention, the contacting operation is carried out with heating at a temperature from at least 1° C. to 5° C. below or equal to the boiling point of the solvent having the lowest boiling point, for instance 45° C. Whatever the temperature at which a) is brought into contact with b), this contacting operation is carried out in a round-bottomed flask made of glass or of metal, an industrial or non-industrial vessel made of glass or of metal (stainless steel), having a single wall or a jacket, or any other reactor suitable for receiving solvents and natural materials. The duration of maceration or infusion of said a)+b) mixture is preferably between a few seconds and a week, more particularly between 30 minutes and 48 hours, even more particularly between 1 hour and 36 hours, better still between 2 hours and 24 hours, even better still between 2 hours and 6 hours. The maceration or infusion can be carried out with stirring, i.e. the a)+b) mixture can be kept stirred mechanically, preferably at a rotational speed of between 10 rpm and 1200 rpm, in particular between 100 rpm and 900 rpm, even more particularly between 200 rpm and 850 rpm, for instance 200 rpm. According to a particular embodiment of the invention, in the contacting operation the mass ratio between the the solvent(s)/natural material(s) (especially biomass(es)) is between 1/1 to 20/1, preferably between 5/1 and 10/1, such as 9/1.

According to one embodiment, after mixing a)+b), said mixture is subjected to a sonication step, in particular by putting said mixture in a high- or low-frequency ultrasonic bath, preferably at frequencies of between 5 and 40 kHz. Preferably, the sonication time is of between 5 seconds and 1 hour, more preferentially of between 10 seconds and 30 minutes, more preferentially still between 30 seconds and 10 minutes, such as 5 minutes. The temperature during this sonication step is between 0° C. and 90° C., preferably between 5° C. and 45° C.

According to one embodiment, after mixing a)+b), a sonication of said mixture is optionally carried out as defined above; followed by a step of heating said mixture at a temperature above 20° C., particularly above 30° C., more particularly at a temperature above 35° C., even more particularly up to reflux of said solvent(s) of the system of solvents; preferably said mixture is heated to a temperature of between 40° C. and 100° C. Preferentially, the a)+b) mixture is heated for a period of time of between 5 minutes and 48 hours, particularly between 30 minutes and 24 hours, more particularly between 1 hour and 12 hours, even more preferentially between 2 hours and 5 hours.

The a)+b) mixture can be kept stirred mechanically, preferably at a rotational speed in particular of between 10 rpm and 1200 rpm, in particular between 100 rpm and 900 rpm, more particularly still between 200 rpm and 850 rpm, for instance 200 rpm.

According to a particular embodiment, during the heating of the mixture, the reactor in which the a)+b) mixture is found comprises a cooling system or condenser for cooling and condensing the solvent(s) of the system of solvent(s) a). More preferentially, the reactor is an extractor of Soxhlet type or a reactor provided with a mechanical stirrer and equipped with a water-cooled or helical condenser, preferably a reactor provided with a mechanical stirrer and equipped with a water-cooled or helical condenser. In the latter case, the system of solvent(s) is advantageously brought to reflux of said solvent(s) of the system of solvent(s), comprising at least one ketone solvent and/or at least one dioxolane-type solvent, at a temperature above or equal to 25° C. and particularly a boiling point at atmospheric pressure below or equal to 180° C., more particularly between 50° C. and 160° C., preferably between 57° C. and 150° C.; more preferentially between 60° C. and 130° C., even more particularly between 70° C. and 120° C., notably the ketone and/or dioxolane-type solvent(s) is(are) chosen from a1) to a3) as defined above. Preferentially, the a)+b) mixture is heated for a period of time of between 5 minutes and 48 hours, particularly between 30 minutes and 24 hours, more particularly between 1 hour and 12 hours, even more preferentially between 2 hours and 5 hours.

According to a particular embodiment of the invention, after the step of heating the a)+b) mixture, the mixture is allowed to return to ambient temperature or cooled to ambient temperature and is left, optionally under mechanical stirring as defined above, particularly between 30 minutes and 48 hours, more particularly still between 1 hour and 36 hours, better still between 2 hours and 24 hours.

More particularly, the contacting step is a “solid/liquid extraction” step.

According to a particular embodiment, the solid/liquid extraction step is carried out by means of a Soxhlet extractor. In the latter case, the system of solvents is advantageously brought to reflux of said solvent(s) of the system of solvent(s), in particular at a temperature above or equal to 25° C.; and particularly a boiling point at atmospheric pressure below or equal to 180° C., more particularly between 50° C. and 160° C., preferably between 57° C. and 150° C.; more preferentially between 60° C. and 130° C., even more particularly between 70° C. and 120° C.

According to a particular embodiment, the solid/liquid extraction step is carried out by means of a reactor provided with a mechanical stirrer and equipped with a water-cooled or helical condenser. In the latter case, the system of solvents is advantageously brought to reflux of said solvent(s) of the system of solvent(s), in particular at a temperature above or equal to 25° C.; and particularly a boiling point at atmospheric pressure below or equal to 180° C., more particularly between 50° C. and 160° C., preferably between 57° C. and 150° C.; more preferentially between 60° C. and 130° C., even more particularly between 70° C. and 120° C.

According to another variant when for example the plant natural material(s) is(are) flowers, notably jasmine flowers, mimosa flowers, or Vanilla seeds and/or pods, the system of solvents is not brought to reflux, but maintained at a temperature at least 1° C. to 5° C. below or equal to the boiling point of the solvent having the lowest boiling point, notably below or equal to 35° C. The contacting and solid/liquid extraction step is followed by a step of recovering the natural extract, preferably plant natural extract, resulting from the natural material(s), preferably plant natural material(s). This recovery can be carried out by filtration, distillation or with an extractor of Soxhlet type. According to one embodiment, the recovery is carried out by filtration for example on paper.

The solvent(s) of the extract(s) can be removed by desolventization. Mention may be made, for example, as desolventization process, of the evaporation of solvent(s), preferably under vacuum, for example using a rotary evaporator combined with a vacuum pump, an industrial evaporator, or else with a distillation apparatus, in order to obtain, after separation, extraction and evaporation of the solvent(s), a perfume concrete.

According to another variant of the process of the invention, the step of recovering the extract is carried out by separation of the natural material(s) which has(have) not been dissolved (also called precipitate) from its supernatant comprising said solvent(s). The separation of the precipitate from the solvent(s) is carried out by conventional methods known to a person skilled in the art. Mention may be made, for example, of the filtration method, or chromatography. The solvent(s) can be removed from the supernatant by desolventization as defined above; if need be, said desolventized supernatant can be purified again by one or more conventional purification method(s) known to a person skilled in the art. Mention may be made, for example, of chromatography, distillation, optionally under reduced pressure, and/or recrystallization, in order to obtain a concrete. The concrete is relatively viscous and may be in the form of a thick waxy residue.

According to a particular embodiment, the preparation process of the invention is a process for preparing a perfume concrete employing:
1) at least one step of bringing:
   a) a first system of solvents comprising at least one ketone solvent and/or at least one dioxolane solvent, said solvent(s) having a boiling point at atmospheric pressure between 57° C. and 160° C., preferably between 57° C. and 150° C.; more preferentially between 60° C. and 130° C., even more particularly between 70° C. and 120° C. Notably, the ketone and/or dioxolane-type solvent(s) is(are) chosen from a1) to a3) as defined above; into contact with
   b) one or more solid natural material(s) chosen from i) to x) as defined above; then
2) the a)+b) mixture is optionally subjected to a sonication step, in particular by putting said mixture in an ultrasonic bath; preferably, the sonication time is of between 5 seconds and 1 hour, more preferentially of between 10 seconds and 30 minutes, even more preferentially between 30 seconds and 10 minutes, for instance 5 minutes;
3) followed by a step of heating the a)+b) mixture at a temperature above 25° C. and particularly at a boiling point at atmospheric pressure below or equal to 180° C., more particularly between 50° C. and 160° C., preferably between 57° C. and 150° C.; more preferentially between 60° C. and 130° C., even more particularly between 70° C. and 120° C. Preferably, the reactor in which the a)+b) mixture is found comprises a cooling system or condenser; more preferentially, the reactor is an extractor of Soxhlet type or a distillation apparatus; preferentially, the a)+b) mixture is heated for a period of time of between 5 minutes and 48 hours, particularly between 30 minutes and 24 hours, more particularly between 1 hour and 12 hours, even more preferentially between 2 hours and 5 hours;
then
4) the solvent(s) of the extract is(are) removed, preferably under vacuum, for example using a rotary evaporator combined with a vacuum pump, an industrial evaporator, or else with a distillation apparatus, to result in the concrete; or else the natural material(s) which has(have) not been dissolved is(are) separated from its(their) supernatant(s), the separation being carried out preferably by filtration or by chromatography; the supernatant(s) can subsequently be separated and recovered and the solvent(s) of said supernatant(s) is(are) removed by evaporation of solvents as defined above, to result in the concrete.

According to a preferred embodiment, the preparation process of the invention is a process for preparing a perfume concrete employing:
1) at least one step of bringing:
   a) a first system of solvents comprising at least one ketone solvent and/or at least one dioxolane solvent, said solvent(s) having a boiling point at atmospheric pressure between 57° C. and 160° C., preferably between 57° C. and 150° C.; more preferentially between 60° C. and 130° C., even more particularly between 70° C. and 120° C. Notably, the ketone and/or dioxolane-type solvent(s) is(are) chosen from a1) to a3) as defined above; into contact with
   b) one or more solid natural material(s) chosen from i) to x) as defined above, preferably v); then
2) the a)+b) mixture is optionally subjected to a sonication step, in particular by putting said mixture in an ultrasonic bath; preferably, the sonication time is of between 5 seconds and 1 hour, more preferentially of between 10 seconds and 30 minutes, even more preferentially between 30 seconds and 10 minutes, for instance 5 minutes;
3) the system of solvents is maintained at a temperature at least 1° C. to 5° C. below or equal to the boiling point of the solvent having the lowest boiling point, notably at a temperature below or equal to 35° C.; the contacting and solid/liquid extraction step is followed by a step of recovery of the natural extract, preferably plant natural extract, resulting from the natural material(s), preferably plant natural material(s); this recovery can be carried out by filtration, distillation, or with a Soxhlet extractor, preferably by filtration for example on paper; preferentially the a)+b) mixture is maintained at a temperature at least 1° C. to 5° C. below or equal to the boiling point of the solvent having the lowest boiling point, notably at a temperature below or equal to 45° C., for a time of between 5 minutes and 48 hours, particularly between 30 minutes and 24 hours, more particularly between 1 hour and 12 hours, even more particularly between 2 hours and 5 hours;
then
4) the solvent(s) of the extract is(are) removed, preferably under vacuum, for example using a rotary evaporator combined with a vacuum pump, an industrial evaporator, or else with a distillation apparatus, to result in the concrete; or else the natural material(s) which has(have) not been dissolved is(are) separated from its(their) supernatant(s), the separation being carried out preferably by filtration or by chromatography; the supernatant(s) can subsequently be separated and recovered and the solvent(s) of said supernatant(s) is(are) removed by evaporation of solvents as defined above, to result in the concrete.

The concrete(s) obtained with the process of the invention can also be used or packaged in a wax or in a natural fatty substance.

### The Second System of Solvent(s)

According to an advantageous variant in the process of the invention, the concrete is brought into contact with at least one second system of polar solvent(s), preferably polar protic solvent(s), comprising at least one polar protic solvent, in particular (C₂-C₆)alkanol, which is(are) preferably “green” or of natural origin, such as bioethanol.

According to one embodiment of the invention, the second system of solvent(s) comprises at least one polar protic solvent, in particular chosen from (C₂-C₆)alkanols, which are preferably “green” or of natural origin, such as bioethanol, in an amount representing at least 10% by volume relative to the total volume of the second solvent system, more preferentially at least 30%, even more preferentially at least 60%, preferably at least 80%, better still at least 90% by weight, even better still 100% by weight relative to the total volume of the second solvent system. When the second solvent system comprises a mixture of solvents, preferably the solvent system comprises two solvents and the preferred additional solvent is of the same polarity as the first solvent and is miscible with the first solvent; more particularly, the second solvent of the second solvent system is water. Preferably, there is only a single solvent in the second solvent system, which is ethanol, more particularly bioethanol.

According to an advantageous variant of the invention, once the second system of polar protic solvent(s) has been added to the concrete, the concrete+solvent(s) mixture is maintained at a temperature below 0° C., more preferentially below or equal to −10° C. Subsequently, the pellet is separated from the supernatant, preferably by centrifuging, then the solvent(s) is(are) evaporated from the supernatant, preferably under vacuum, for example using a rotary evaporator combined with a vacuum pump, an industrial evaporator, or else with a distillation apparatus, in order to obtain, after separation, and evaporation of the solvent(s), a perfume absolute.

According to another variant, the step of bringing the concrete into contact with the second system of solvent(s) can be carried out with or without stirring, preferably with stirring. The operation of bringing the concrete into contact with the second system of solvent(s) can be carried out at a temperature of between 10° C. and 37° C., such as 25° C., in the system of solvent(s) as defined above, or at a temperature 1° C. to 5° C. below or equal to the boiling point of the solvents having the lowest boiling point, in a round-bottomed flask made of glass or of metal (stainless steel), an industrial or non-industrial vessel made of glass or of metal (stainless steel), or any other reactor suitable for receiving solvents, natural materials and concrete.

The duration of the operation of bringing the concrete into contact with the second system of solvent(s) is preferably between a few seconds and 2 days, more particularly between 5 minutes and 24 hours, even more particularly between 10 minutes and 12 hours, better still between 15 minutes and 2 hours.

According to a particular embodiment of the process of the invention, the operation of bringing the concrete into contact with the second system of solvent(s) is followed by a sonication step, in particular by putting said mixture in an ultrasonic bath. Preferably, the sonication time is of between 5 seconds and 1 hour, more preferentially of between 10 seconds and 30 minutes, even more preferentially between 30 seconds and 10 minutes, such as 5 minutes.

According to a preferred embodiment, the mixture of the concrete and of the second system of solvent(s) is maintained at a temperature below 0° C., more preferentially below or equal to −10° C., for a period of time of between 5 minutes and 48 hours, particularly between 5 minutes and 24 hours, more particularly between 5 minutes and 2 hours, even more preferentially between 5 minutes and 1 hour. Subsequently, the pellet is separated from the supernatant, preferably by centrifuging, then the solvent(s) is(are) evaporated from the supernatant, preferably under vacuum, for example using a rotary evaporator combined with a vacuum pump, an industrial evaporator, or else with a distillation apparatus, in order to obtain, after separation, and evaporation of the solvent(s), a perfume absolute.

According to a variant of the process of the invention, the step of recovery of the absolute is carried out by separation of the precipitate of the concrete which has not been dissolved in the second system of solvent(s) and of its supernatant comprising said solvent(s) of the second system of solvent(s).

The separation of the precipitate of the concrete and of the supernatant is carried out by conventional methods known to a person skilled in the art. Mention may be made, for example, of the filtration method, or chromatography.

The solvent(s) of the second system of solvent(s) can be removed from the supernatant by desolventization as defined above, preferably by evaporation under reduced pressure; if need be, said desolventized supernatant can be purified again by carrying out at least one conventional purification method known to a person skilled in the art. Mention may be made, for example, of chromatography, distillation, optionally under reduced pressure, and/or recrystallization, in order to obtain an absolute.

The absolutes are generally viscous and oily, optionally coloured, materials.

According to a particular embodiment of the invention, the concretes and absolutes, both obtained by total extraction of plant solid natural material and not being subjected to any form of distillation other than the removal of the solvents by desolventization, are complex mixtures containing numerous chemical types over a broad weight scale. Even if the volatile materials comprise only a very small part of the total, the concretes and absolutes obtained with the process of the invention have powerful odours and contribute to the perfumes in which they are used. Furthermore, the odours are long-lasting.

### The Composition:

Another subject of the invention is a composition, in particular a cosmetic composition, preferably a perfuming composition, comprising at least one concrete and/or at least one absolute, it being understood that said concrete(s) and/or said absolute(s) is(are) obtained by the preparation process as defined above.

According to one embodiment, the composition of the invention contains one or more concrete(s) obtained with the preparation process as defined above.

According to a preferred embodiment, the composition of the invention contains one or more absolute(s) obtained with the preparation process as defined above.

The cosmetic compositions according to the invention are cosmetically acceptable, i.e. they comprise only ingredients which are cosmetic ingredients, i.e. which do not detrimentally affect keratin materials and which are suitable for a cosmetic use.

According to one particular embodiment of the invention, the composition is anhydrous. When the composition is anhydrous, it generally comprises one or more fatty substances, which are liquid at 25° C. and atmospheric pressure, pasty substances, or substances in the form of waxes. The liquid fatty substances, pasty substances and waxes are more particularly as defined below.

According to another embodiment of the invention, the composition is aqueous. Generally, the compositions of the invention comprise a support which generally contains water or a mixture of water and of one or more organic solvents or a mixture of organic solvents; preferably, the organic solvent(s) of the composition is(are) “green”.

### Organic Solvents:

Examples of organic solvents that may be mentioned include C₂-C₄ lower alkanols, such as ethanol and isopropanol; polyols and polyol ethers such as 2-butoxyethanol, propylene glycol, propylene glycol monomethyl ether, diethylene glycol monoethyl ether, diethylene glycol monomethyl ether, hexylene glycol, and also aromatic alcohols, such as benzyl alcohol or phenoxyethanol.

According to a particular embodiment, the perfuming composition is aqueous. More particularly, it is an aqueous-alcoholic composition comprising (C₂-C₄)alkanols which are more particularly “green”, preferably ethanol which is more preferentially “green”, such as bioethanol. The amount of organic solvent, which is preferably “green”, and in particular of (C₂-C₄)alkanols, is preferably of between 1% by weight and 80% by weight, more particularly between 5% and 50% by weight, preferentially between 10% and 30% by weight, with respect to the total weight of the perfuming composition.

According to a particular embodiment, the organic solvents, which are preferably “green”, and in particular the (C₂-C₄)alkanols, are present in proportions of between 1% and 40% by weight approximately relative to the total weight of the composition, and even more preferentially between 5% and 30% by weight approximately.

### Adjuvants:

The composition(s) of the invention may also contain various adjuvants conventionally used in cosmetic compositions, such as anionic, cationic, nonionic, amphoteric or zwitterionic emulsifiers or surfactants or mixtures thereof, anionic, cationic, nonionic, amphoteric or zwitterionic polymers or mixtures thereof, mineral or organic thickeners, and in particular anionic, cationic, nonionic and amphoteric polymeric associative thickeners, antioxidants, penetrants, sequestrants, fragrances other than those of the concrete or absolute of the invention, antiperspirants, buffers, dispersants, conditioning agents, film-forming agents, ceramides, preserving agents, opacifiers and fatty substances, notably oils.

The above adjuvants are generally present in an amount for each of them of between 0.01% and 40% by weight relative to the weight of the composition, and preferably between 0.1% and 20% by weight relative to the weight of the composition.

Of course, a person skilled in the art will take care to choose this or these optional additional compound(s) in such a way that the advantageous properties intrinsically attached to the composition(s) of use in the method for perfuming or for treating keratin materials in accordance with the invention are not, or not substantially, detrimentally affected by the envisaged addition(s).

The compositions according to the invention may be packaged in the form of bottles. They can also be applied in the form of fine particles by means of pressurization devices. The devices in accordance with the invention are well known to a person skilled in the art and comprise non-aerosol pumps or “atomizers”, aerosol containers comprising a propellant and also aerosol pumps using compressed air as propellant. The latter are described in U.S. Pat. Nos. 4,077,441 and 4,850,517 (forming an integral part of the content of the description).

The compositions packaged as an aerosol in accordance with the invention generally contain conventional propellants, such as, for example, hydrofluorinated compounds, dichlorodifluoromethane, difluoroethane, dimethyl ether, isobutane, n-butane, propane or trichlorofluoromethane, preferably isobutane, n-butane or propane.

The compositions according to the invention may be in any presentation form conventionally used for topical application and notably in the form of aqueous or aqueous-alcoholic solutions, of oil-in-water (O/W), water-in-oil (W/O) or multiple (triple: W/O/W or O/W/O) emulsions, of aqueous gels, of dehydrated anhydrous products, such as free or compact perfuming powders, or of dispersions of an oily phase in an aqueous phase using lipid vesicles of ionic type (liposomes) and/or nonionic type. These compositions are prepared according to the usual methods.

In addition, the compositions according to the invention may be more or less fluid and may have the appearance of a liquid, a cream, an ointment, a milk, a lotion, a serum, a paste or a foam. They may also be in solid form, for example in the stick form.

When the composition according to the invention comprises an oily phase, it preferably contains at least one oil, in particular a physiologically acceptable oil. It may contain fatty substances other than oils, in particular plant oils, more preferentially natural oils.

### The Method for Treating Keratin Materials:

Preferably, the method for treating keratin materials of the invention is a method for treating human keratin materials, such as the skin, or human keratin fibres, such as the hair, employing the application of one or more concrete(s) and/or of one or more absolute(s) obtained from the preparation process as defined above, it being understood that said concrete(s) and/or the absolute(s) can be contained in a composition as defined above.

More preferentially, the method for treating keratin materials of the invention is a method for treating human keratin materials, such as the skin, or human keratin fibres, such as the hair, employing the application of one or more absolute(s), obtained from the preparation process as defined above, it being understood that the absolute(s) can be contained in a composition as defined above.

The invention will now be described with reference to the examples that follow, which are given as non-limiting illustrations. In these examples, unless otherwise indicated, the amounts are expressed as percentages by weight. The following scented compositions were prepared, the amounts are shown as percentages by weight.

### EXAMPLES

### Solvents

Ethanol denotes 96% ethanol.

Vanilla, or Vanilla planifolia, belongs to the family Orchidaceae.

The flowers, joined in groups of 8 to 10, resemble those of numerous orchids. They are scented and white or green-yellow in colour. Vanilla flowers in autumn-winter between September and January, depending on the cultivation zone. It produces long stems of violet-scented flowers.

The ripe fruit is completely odourless; its unique and valued odour is acquired after a fermentation process. This valued fruit owes its characteristic odour to the odorous principle called vanillin. The fruits or pods alone are used for the extraction. The dried biomass, finely ground with a grinder of IKA A11 mill type (size of a few millimetres), is ready for use and is then brought into contact with the various solvents, with a 1:9 ratio (1 g of biomass per 9 ml of solvent).

### Experimental Protocol 1:

20 g of dried Vanilla pods are pre-ground, and placed in a 500-ml round-bottomed flask. The extraction solvent (180 g) is then added to the biomass. The round-bottomed flask is then positioned on a Rotavapor system, the round-bottomed flask dipping into the bath thermostatically maintained at 20° C. Said round-bottomed flask is then placed under stirring (200 rpm) for 2 hours. The mixture is then filtered over a pleated filter then the solvent is evaporated until a coloured residue corresponding to the concrete is obtained. The latter is then taken up in ethanol (30 ml) at low temperature (0° C.) in order to precipitate the waxes. After separating the latter in the centrifuge (3000 rpm, 15 min at 19° C.), the supernatant is drawn off then evaporated under vacuum to result in the absolute.

### Experimental Protocol 2:

20 g of dried Vanilla pods are pre-ground, and placed in a 500-ml round-bottomed flask. The extraction solvent (180 g) is then added to the biomass. The round-bottomed flask is then positioned on a Rotavapor system, the round-bottomed flask dipping into the bath thermostatically maintained at 40° C. The round-bottomed flask is then placed under stirring (200 rpm) for 2 hours. The mixture is then filtered over a pleated filter then the solvent is evaporated until a coloured residue is obtained in order to result in the concrete. The latter is then taken up in ethanol (30 ml) at low temperature in order to precipitate the waxes. After separating the latter in the centrifuge (3000 rpm, 15 min at 19° C.), the supernatant is drawn off then evaporated under high vacuum to result in the absolute.

Vanilla, or Vanilla planifolia, belongs to the family Orchidaceae. The tests of Examples 1 to 9 are carried out with ketone and dioxolane solvents on the Vanilla (Vanilla platifolia) extract according to the experimental protocols prot. 1 and prot. 2, Examples 1 to 5 being according to the invention, 6 to 9 being comparative examples with the comparative n-heptane and acetone solvents respectively.

### Preparation of the Solid Natural Material:

TABLE 1

| | | | | | | Amount |
|---|---|---|---|---|---|---|
| | | | | | | raw mat. |
| | | | | Weight | Weight | diluted |
| | Solvent | | | of | of | (30% |
| Ex. | (Solv.) | Chemical name | Prot. | concrete | absolute | ethanol) |
| 1 | 6) | Methyl isobutyl | 1 | 1.7 g | 1.51 g | 5.03 g |
| | | ketone | | | | |
| 2 | 6) | Methyl isobutyl | 1 | 1.6 g | 1.61 g | 5.36 g |
| | | ketone | | | | |
| 3 | 18) | 2-ethyl-2-methyl- | 2 | 6.3 g | 5.2 g | 4.13 g |
| | | 1,3-dioxolane | | | | |
| 4 | 9) | 3-pentanone | 1 | 1.95 g | 1.5 g | 5 g |
| 5 | 9) | 3-pentanone | 2 | 2.06 g | 1.65 g | 5.5 g |
| 6 | Comp. | n-heptane | 1 | 0.6 g | 0.75 g | 2.5 g |
| | 1 | | | | | |
| 7 | Comp. | n-heptane | 2 | 1.04 g | 0.85 g | 2.38 g |
| | 2 | | | | | |
| 8 | Comp. | acetone | 1 | 2.81 g | 2.04 g | 6.8 g |
| | 3 | | | | | |
| 9 | Comp. | acetone | 2 | 2.69 g | 2.19 g | 7.3 g |
| | 4 | | | | | |

The solvents comp. 1, 2, 3 and 4 are comparative solvents outside of the invention.

It appears that the concretes and absolutes obtained with the process according to the invention have a higher yield than those obtained with the solvents comp. 1 and 2. In addition, the Vanilla absolutes obtained with the solvents of the invention are more pleasant in terms of olfaction, identical, on the olfactory level, to the fragrance of the starting Vanilla raw material. By way of example, the methyl isobutyl ketone solvent 6) makes it possible to obtain odours of absolutes that are very powerful, very fruity, not very fatty, very faceted, very sweet, not very straw-like and with the 3-pentanone solvent 9) the absolutes are very intense and powerful, very pod-like with notes of rum.

### Example 10

20 g of dried Vanilla pods are pre-ground with a grinder of the IKA A 11 type grinder (size of a few millimeters) then brought into contact with methyl ethyl ketone, with a ratio of 1:9 (1 g of dry biomass for 9 mL of solvent), put in a 500 ml flask. The extraction solvent (180 g) is then added to the biomass. The flask is then placed on a Rotavapor type system, the flask immersing in the bath thermostated at 40° C. The flask is then stirred (200 revolutions/min) for 2 hours. The mixture is then filtered on a pleated filter then the solvent is evaporated under high vacuum until a colored residue is obtained to lead to the concrete. The latter is then taken up in ethanol (30 ml) cold in order to precipitate the waxes. After separation of the latter in a centrifuge (3000 rpm, 15 min at 19° C.), the supernatant is removed and then evaporated under high vacuum to yield the absolute.

### Preparation of the Solid Natural Material:

TABLE 2

| | | | | | Amount raw |
|---|---|---|---|---|---|
| | | | Weight of | Weight of | mat. diluted |
| Ex. | Solv. | Chemical name | concrete | absolute | (30% ethanol) |
| 10 | 2) | methyl ethyl ketone | 1.58 g | 0.9 g | 0.57 g |
| | | (RN CAS 78-98-3) | | | (absolute) |

It appears that the absolute obtained with the process according to the invention is significantly more greedy, intense and powerful, fruity, caramel, addictive, and more harmonious than that obtained with comparative acetone (ex. 9 comp. 4 above). It is very close to extracted biomass, and much closer than absolute obtained with acetone (ex. 9).

### Example 11

### Preparation of the Solid Natural Material:

Lavandin, or Lavandula augustifolia, belongs to the Lamiaceae family.

This plant produces long stems of fragrant purple flowers. These are collected and then used for extraction. The stem is not used in order to avoid obtaining an overly herbaceous perfume note.

20 g of dried lavandin flowers are placed in a 500 ml flask. The extraction solvent (180 g) is then added to the biomass. The flask is then placed on a Rotavapor type system, the flask immersing in the bath thermostated at 40° C. The flask is then stirred (200 revolutions/min) for 2 hours. The mixture can be then filtered on a pleated filter and then the solvent is evaporated until a colored residue is obtained to produce the concrete. The latter can be then taken up in ethanol (30 ml) cold (0° C.) in order to precipitate the waxes. After separation of the latter in a centrifuge (3000 rpm, 15 min at 19° C.), the supernatant is removed and then can be evaporated under high vacuum to produce the absolute.
The following test with lavandin biomass was carried out:

TABLE 3

| | | | | | Amount raw |
|---|---|---|---|---|---|
| | | | Weight of | Weight of | mat. diluted |
| Ex. | Solv. | Chemical name | concrete | absolute | (23% ethanol) |
| 11 | 16) | 2-methylcyclo- | 1.64 g | 1.06 g | 0.57 g |
| | | pentanone (RN | | | (absolute) |
| | | CAS 1120-72-5), | | | |

### Olfactory Evaluation:

It appears that the absolute obtained with the process according to the invention is aromatic, not too terpenic, slightly camphorated, very close on the olfactory level to the extracted biomass.

### Example 12 to 14 and Comparative Example 15 with Acetone

The Tonka bean, or coumarou, is a seed produced by several species of tropical trees of the Fabaceae family of the Dipteryx and Taralea genera: mainly Dipteryx odorata, but also, in particular, Dipteryx alata and Taralea oppositifolia.

### Experimental Protocol 1:

20 g of Tonka beans are pre-ground with a grinder of the IKA A 11 type grinder (size of a few millimeters), placed in a 500 ml flask. The extraction solvent (180 g) is then added to the biomass. The flask is then placed on a system of the Rotavapor type, the flask immersing in the bath thermostated at 20° C. (Room Temperature). Said flask is then stirred (200 revolutions/min) for 2 hours. The mixture can be then filtered and the solvent can be evaporated under high vacuum until a colored residue corresponding to the concrete is obtained. The latter can be then taken up in ethanol (30 ml) cold (0° C.) in order to precipitate the waxes. After separation of the latter in a centrifuge (3000 rpm, 15 min at 19° C.), the supernatant can be removed and then evaporated under vacuum at 40° C. to produce the absolute.

### Experimental Protocol 2:

20 g of Tonka beans are pre-ground with a grinder of the IKA A 11 grinder type (size of a few millimeters), placed in a 500 ml flask. The extraction solvent (180 g) is then added to the biomass. The flask is then placed on a Rotavapor-type system, the flask immersing in the bath thermostated at 40° C. Said flask is then stirred (200 revolutions/min) for 2 hours. The mixture can be then filtered and then the solvent can be evaporated under high vacuum until a colored residue corresponding to the concrete is obtained. The latter is then taken up in ethanol (30 ml) cold (0° C.) in order to precipitate the waxes. After separation of the latter in a centrifuge (3000 rpm, 15 min at 19° C.), the supernatant can be removed and then evaporated under vacuum at 40° C. to produce the absolute.

The following tests with Tonka beans were carried out:

TABLE 4

| | | | | | | Amount |
|---|---|---|---|---|---|---|
| | | | | Weight | Weight | raw mat. |
| | Solvent | | | of | of | diluted (23% |
| Ex. | (Solv.) | Chemical name | Prot. | concrete | absolute | ethanol) |
| 12 | 6) | Methyl isobutyl- | 2 | 3.91 g | 1.75 g | 0.5 g |
| | | ketone (RN | | | | (Absolute) |
| | | CAS 108-10-1) | | | | |
| 13 | 6) | Methyl isobutyl- | 1 | 3.52 g | 1.41 g | 0.5 g |
| | | ketone (RN | | | | (Absolute) |
| | | CAS 108-10-1) | | | | |
| 14 | 2) | Methyl ethyl | 2 | 4.91 g | 1.81 g | 0.46 g |
| | | ketone (RN | | | | (Absolute) |
| | | CAS 78-98-3) | | | | |
| 15 | Comp. | acetone | 2 | 2.04 g | 1.91 g | 0.93 g |
| | 5 | (CAS 67-64-1) | | | | (Absolute) |

### Olfactory Evaluation:

The Tonka bean concretes obtained with the solvents of the invention have a much better yield than that obtained with the comparative solvent acetone (ex. 15, comp. 5). The yields of the absolutes according to the invention are on the other hand almost identical to that obtained with the comparative solvent acetone. Examples 12, 13 and 14 have been compared to example 15 (comp. 3). The Tonka absolutes obtained according to the invention have a lingering coumarin, Vanilla, subtle amber note that is more intense and powerful than that obtained with the comparative acetone of example 15. In addition, the coumarin note of the absolute obtained with acetone is much lighter. In conclusion, the absolutes obtained according to the invention are significantly closer to the extracted biomass than the one obtained with comparative solvent acetone of example 15.

### Example 16

Orange blossom, also called “Essence of Neroli”, named after the town of Nérola, comes from the bitter orange tree (Citrus sinensi, Citrus aurantium). This rustic tree belonging to the Rutaceae family can live up to 600 years. This small white flower is particularly appreciated for its intense and powerful, sweet and delicate fragrance.

### Experimental Protocol:

20 g of orange blossoms are placed in a 500 ml flask. The extraction solvent (180 g) is then added to the biomass. The flask is then placed on a Rotavapor type system, the flask immersing in the bath thermostated at 40° C. Said flask is then stirred (200 revolutions/min) for 2 hours. The mixture can be then filtered then the solvent can be evaporated under high vacuum until a colored residue corresponding to the concrete is obtained. The latter is then taken up in ethanol (30 ml) cold (0° C.) in order to precipitate the waxes. After separation of the latter in a centrifuge (3000 rpm, 15 min at 19° C.), the supernatant can be removed and then evaporated under vacuum at 40° C. to produce the absolute.

The following test with orange blossoms was carried out:

TABLE 5

| | | | | | Amount raw |
|---|---|---|---|---|---|
| | | | Weight of | Weight of | mat. diluted |
| Ex. | Solv. | Chemical name | concrete | absolute | (12.3% ethanol) |
| 16 | 6) | Methyl isobutyl | 0.23 g | 0.14 g | 0.14 g |
| | | ketone (RN CAS | | | (absolute) |
| | | 108-10-1) | | | |

### Olfactory Evaluation:

The orange blossom absolute obtained previously provides a powerful, solar white flower note. The Absolute obtained is very close olfactorily to the extracted biomass.

### Example 17

Acacia dealbata is a species of tree, commonly referred to as mimosa flowers, “winter mimosa” or “florist's mimosa”, belonging to the Mimosoideae subfamily.

### Experimental Protocol:

20 g of mimosa flowers are placed in a 500 ml flask. The extraction solvent (180 g) is then added to the biomass. The flask is then placed on a Rotavapor type system, the flask immersing in the bath thermostated at 40° C. Said flask is then stirred (200 revolutions/min) for 2 hours. The mixture is then filtered on a pleated filter then the solvent is evaporated under high vacuum until a slightly yellow residue corresponding to the concrete is obtained. The latter is then taken up in ethanol (30 ml) cold (0° C.) in order to precipitate the waxes. After separation of the latter in a centrifuge (3000 rpm, 15 min at 19° C.), the supernatant is removed and then evaporated under vacuum at 40° C. to produce the absolute.

The following test with mimosa flowers was carried out:

TABLE 6

| | | | | | Amount raw |
|---|---|---|---|---|---|
| | | | Weight of | Weight of | mat. diluted |
| Ex. | Solv. | Chemical name | concrete | absolute | (30% ethanol) |
| 17 | 6) | Methyl isobutyl | 2.55 g | 1.5 g | 0.5 g |
| | | ketone (RN CAS | | | (absolute) |
| | | 108-10-1) | | | |

### Olfactory Evaluation:

The mimosa flower absolute obtained previously provides a floral, delicate, honeyed note, a note close to the extracted biomass.

### Examples 18 and 19

### Preparation of the Solid Natural Material:

Jasmine, or Jasminum officinale var. Grandiflorum, belongs to the Oleaceae family.

This plant produces long branched stems variegated with numerous fragrant white flowers. The latter are picked in the early morning and then undergo rapid processing to avoid losing their olfactory properties.
The ready-to-use jasmine flowers (20 g) are then brought into contact with the solvent (180 g), with a 1:9 ratio (1 g of biomass for 10 mL of solvent) in a 500 mL flask. The heterogeneous reaction medium is then stirred (340 rpm) at room temperature and then brought to 40° C. for 2 hours. The reaction medium is then left to return to room temperature.
At the end of the extraction, the macerate can be recovered and filtered in order to remove the biomass residues, then can be placed in a rotary evaporator in order to eliminate the solvent under high vacuum. A yellow-brown viscous liquid is obtained.
The latter is then taken up with absolute ethanol (ratio 0.5/30 (0.5 g of Concrete for 30 g of ethanol)); the alcoholic medium is kept in an ice bath at about −10° C. for half an hour in order to precipitate the waxes in particular, before being centrifuged in an Eppendorf® 5810R centrifuge at 23° C. at 4000 rpm for 15 minutes. The supernatant can be then placed in a flask and in turn to be placed in the rotary evaporator in order to remove the ethanol. Subsequently, the yellow-brown viscous liquid obtained is placed in a desiccator under vacuum at 40° C. for half an hour in order to eliminate any trace of residual solvent. The absolute is then obtained.
The following tests with jasmine flowers were carried out:

TABLE 6

| | | | Amount raw |
|---|---|---|---|
| | | | mat. diluted |
| Ex. | Solv. | Chemical name | (30% ethanol) |
| 18 | 2) | Methyl ethyl ketone | — |
| | | (RN CAS 78-98-3) | |
| 19 | 9) | 3-pentanone | 0.45 g |
| | | (RN CAS 96-22-0) | (absolute) |

### Olfactory Evaluation:

The absolutes from jasmine flower obtained according to the invention (ex. 18 and 19) are intensive and powerful, floral, amber, and very close to the extracted biomass.

1. A process for preparing a perfume concrete and/or a perfume absolute employing at least one step of bringing:
a) a first system of solvents comprising:
at least one ketone solvent, and/or
at least one dioxolane-type solvent,
said solvent(s) having a boiling point at atmospheric pressure between 57° C. and 160° C. into contact with:
b) one or more fresh, withered or dry solid natural materials chosen from:
i) rose (Rosa platyrhodon, Rosa hesperrhodos, Rosa hulthemia and Rosa eurosa) jasmine (Jasminum) flowers, lavender flowers, lavandin (Lavandula stoechas, Lavandula hybrida, Lavandula angustifolia, formerly officinalis, and Lavandula latifolia) flowers, orange (Citrus sinensis) or bitter orange (Citrus aurantium L) blossom, tuberose (Agave polianthes or Polianthes tuberosa) flowers, ylang-ylang (Cananga odorata) flowers, violet (Viola odorata var. Victoria) flowers, and mimosa (Acacia dealbata, Acacia decurrens) flowers;
ii) geranium (Pelargonium) stems and leaves, patchouli (Pogostemon cablin and Pogostemon heyneanus) stems and leaves and petitgrain (Citrus aurantium) stems and leaves;
iii) fruits chosen from anise (Pimpinella anisum), coriander (Coriandrum sativum), caraway (Carum carvi), cumin (Cuminum cyminum) and juniper (Juniperus);
iv) Citrus fruits;
v) mace (Myristica fragrans) seeds, Angelica (Angelica archangelica) seeds, celery (Apium graveolens) seeds and cardamom (Elettaria cardamomum) seeds, tonka (Dipteryx odorata) seeds or beans, Vanilla (Vanilla planifolia) pods and/or seeds;
vi) Angelica (Angelica archangelica) roots, vetiver (Vetiveria) roots and Iris roots; vii) sandalwoods (Santalum), rosewoods (Aniba rosaeodora), cedarwoods (Cedrus) and lignum vitae (Bulnesia sarmientoi, Guaiacum officinale and Guaiacum sanctum);
viii) herbs and grasses chosen from tarragon (Artemisia dracunculus), lemongrass (Cymbopogon), sage (Salvia), mint (Mentha) and thyme (Thymus);
ix) spruce needles and twigs, fir (Abies) needles and twigs, rosemary (Salvia rosmarinus, formerly Rosmarinus officinalis) needles and twigs, and pine (Pinus) needles and twigs; and
x) resins and balms derived from galbanum (Ferula galbaniflua or Ferula gummosa), elemi (Canarium), benzoin (Styrax), myrrh (Commiphora myrrha or Commiphora molmol and Commiphora opobalsamum) and olibanum (Boswellia);
it being understood that:
the seeds or beans v) can be with or without shells; and
when the first system of solvents comprises at least one ketone solvent which is acetone, then the acetone is not mixed with the hexane.

2. The process according to claim 1, in which said solvent(s) has(have) a boiling point at atmospheric pressure between 57° C. and 150° C.

3. The process according to claim 1, in which the first solvent system a) comprises:
at least one ketone solvent.

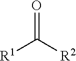

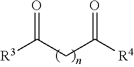

4. The process according to claim 1, in which the first solvent system a) comprises:
at least one dioxolane-type solvent a3), di(C₁-C₇)alkyldioxolane, and also the optical isomers thereof.

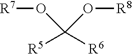

5. The process according to claim 1, in which the first solvent system a) comprises at least one ketone solvent and/or at least one dioxolane solvent, chosen from: 2) methyl ethyl ketone (CAS RN 78-98-3), 3) methyl propyl ketone (CAS RN 107-87-9), 4) methyl butyl ketone (CAS RN 591-78-6), 5) methyl isopropyl ketone (CAS RN 563-80-4), 6) methyl isobutyl ketone (CAS RN 108-10-1), 7) 3-methyl-2-pentanone (CAS RN 565-61-7), 8) tert-butyl methyl ketone (CAS RN 75-97-8), 9) 3-pentanone (CAS RN 96-22-0), 10) 3-hexanone (CAS RN 589-38-8), 11) ethyl isopropyl ketone (CAS RN 565-69-5), 12) 2,4-dimethyl-3-pentanone (CAS RN 580-80-0), 13) 2-methyl-3-hexanone (CAS RN 7379-12-6), 14) 2-methyl-3-pentanone (CAS RN 565-69-5), 15) 2,2-dimethylcyclopentanone (CAS RN 4541-32-6), 16) 2-methylcyclopentanone (CAS RN 1120-72-5), 17) 3-methylcyclopentanone (CAS RN 1757-42-2), 18) 2-methyl-2-ethyl-1,3-dioxolane (CAS RN 126-39-6), 19) 1-hydroxy-2-butanone (CAS RN 5077-67-8), 20) 3-hydroxy-2-butanone or acetoin (CAS RN 51555-24-9 or CAS RN 513-86-0), 21) 3-hydroxy-3-methyl-2-butanone (CAS RN 115-22-0), 22) 2,3-hexanedione (CAS RN 3848-24-6), 23) 3,4-hexanedione (CAS RN 4437-51-8), 24) 2,3-pentanedione (CAS RN 600-14-6), 25) 2,3-butanedione (CAS RN 431-03-8), 26) 2,4-pentanedione (CAS RN 123-54-6).

6. The process according to claim 1, in which the system of solvent(s) comprises at least 50% by volume of ketone and/or dioxolane-type solvent(s) relative to the total volume of the first solvent system.

7. The process according to claim 1, in which the natural material(s) i) to x) has(have) been ground, said grinding operation(s) having been carried out before bringing into contact with the first solvent system a).

8. The process according to claim 1, in which the natural solid raw material(s) b) is(are) dry.

9. The process according to claim 1, in which the operation of contacting a system of solvent(s) a) with b) natural solid material(s) is carried out at ambient temperature, with or without stirring.

10. The process according to claim 1, in which the contacting operation is a solid/liquid extraction step.

11. The process according to claim 1, in which the a)+b) mixture is heated to a temperature above 20° C.

12. The process according to claim 1, in which the reactor in which the a)+b) mixture is found comprises a cooling system or condenser for cooling and condensing the solvent(s) of the system of solvent(s), in order to obtain, after separation, extraction and evaporation of the solvent(s), a perfume concrete.

13. A process for preparing a perfume concrete according to claim 1 implementing:
1) at least one step of bringing:
a) a first system of solvent(s) into contact with
b) one or more solid natural material(s) chosen from i) to x); then
2) the a)+b) mixture is optionally subjected to a sonication step;
3) the system of solvents is maintained at a temperature at least 1° C. to 5° C. below or equal to the boiling point of the solvent having the lowest boiling point; this recovery can be carried out by filtration, distillation, or with a Soxhlet extractor;
4) the solvent(s) of the extract is(are) removed to result in the concrete; or else
the natural material(s) which has(have) not been dissolved is(are) separated from its(their) supernatant(s) to result in the concrete.

14. The process according to claim 12, in which the concrete is brought into contact with at least one second system of polar solvent(s), once the second system of polar solvent(s) has been added, the concrete and solvent(s) mixture is maintained at a temperature below 0° C., then the pellet is separated from the supernatant in order to obtain, after separation, and evaporation of the solvent(s), a perfume absolute.

15. A concrete obtained by the preparation process according to claim 1.

16. A perfume absolute obtained by the preparation process according to claim 14.

17. A composition comprising:
one or more concrete(s) and/or one or more perfume absolute(s) obtained by the preparation process according to claim 1.

18. A method for treating keratin materials, employing the application of one or more concrete(s) and/or one or more perfume absolute(s) obtained by the preparation process according to claim 1, by application of the one or more concrete(s) and/or one or more perfume absolute(s), it being understood that the one or more concrete(s) and/or one or more perfume absolute(s) can be contained in a composition.

19. A method for perfuming:
keratin materials,
textile materials,
wood,
paper,
articles made of leather and/or
the atmosphere,
employing one or more concrete(s) and/or one or more perfume absolute(s) obtained by the preparation process according to claim 1, by applying or spraying the the one or more concrete(s) and/or one or more perfume absolute(s) over the textile(s) or into the ambient air, it being understood that the concrete and/or the absolute can be contained in a composition.

20. A method for extracting one or more concrete(s) and/or one or more perfume absolute(s) obtained by the preparation process according to claim 1 with no chemical odour from b) one or more fresh, withered or dry solid natural materials chosen from:
i) rose (Rosa platyrhodon, Rosa hesperrhodos, Rosa hulthemia and Rosa eurosa) jasmine (Jasminum) flowers, lavender flowers, lavandin (Lavandula stoechas, Lavandula hybrida, Lavandula angustifolia, formerly officinalis, and Lavandula latifolia) flowers, orange (Citrus sinensis) or bitter orange (Citrus aurantium L) blossom, tuberose (Agave polianthes or Polianthes tuberosa) flowers, ylang-ylang (Cananga odorata) flowers, violet (Viola odorata var. Victoria) flowers, and mimosa (Acacia dealbata, Acacia decurrens) flowers;
ii) geranium (Pelargonium) stems and leaves, patchouli (Pogostemon cablin and Pogostemon heyneanus) stems and leaves and petitgrain (Citrus aurantium) stems and leaves;
iii) fruits chosen from anise (Pimpinella anisum), coriander (Coriandrum sativum), caraway (Carum carvi), cumin (Cuminum cyminum) and juniper (Juniperus);
iv) Citrus fruits;
v) mace (Myristica fragrans) seeds, Angelica (Angelica archangelica) seeds, celery (Apium graveolens) seeds and cardamom (Elettaria cardamomum) seeds, tonka (Dipteryx odorata) seeds or beans, Vanilla (Vanilla planifolia) pods and/or seeds;
vi) Angelica (Angelica archangelica) roots, vetiver (Vetiveria) roots and Iris roots; vii) sandalwoods (Santalum), rosewoods (Aniba rosaeodora), cedarwoods (Cedrus) and lignum vitae (Bulnesia sarmientoi, Guaiacum officinale and Guaiacum sanctum);
viii) herbs and grasses chosen from tarragon (Artemisia dracunculus), lemongrass (Cymbopogon), sage (Salvia), mint (Mentha) and thyme (Thymus);
ix) spruce needles and twigs, fir (Abies) needles and twigs, rosemary (Salvia rosmarinus, formerly Rosmarinus officinalis) needles and twigs, and pine (Pinus) needles and twigs; and
x) resins and balms derived from galbanum (Ferula galbaniflua or Ferula gummosa), elemi (Canarium), benzoin (Styrax), myrrh (Commiphora myrrha or Commiphora molmol and Commiphora opobalsamum) and olibanum (Boswellia);
it being understood that:
the seeds or beans v) can be with or without shells; comprising using a system of solvent(s) a) comprising at least one ketone solvent and/or at least one dioxolane solvent, said solvent(s) having a boiling point at atmospheric pressure above or equal to 25° C.

21. A method for the perfuming:
of keratin materials,
of textile materials,
of wood,
of paper,
of articles made of leather, and/or
the atmosphere which method comprises using one or more concrete(s) and/or one or more perfume absolute(s) obtained by the preparation process according to claim 1.
